(19) United States
(12) Patent Application Publication
(10) Pub. No.: US 2011/0111704 A1
(43) Pub. Date: May 12, 2011

(54) WIRELESS TERMINAL AND CONTROL METHOD FOR DIFFUSING SMELL THEREOF

(75) Inventors: Jiyeon Son, Daejeon-city (KR); Junseok Park, Daejeon-city (KR); Changseok Bae, Daejeon-city (KR); Jintae Kim, Daejeon-city (KR)

(73) Assignee: Electronics and Telecommunications Research Institute, Daejeon-city (KR)

(21) Appl. No.: 13/054,016

(22) PCT Filed: Jul. 14, 2009
(86) PCT No.: PCT/KR2009/003847

§ 371 Date: Jan. 13, 2011

(30) Foreign Application Priority Data
Jul. 14, 2008 (KR) 10-2008-0068093

(51) Int. Cl. H04B 7/00

(52) U.S. Cl. 455/68

(57) ABSTRACT

The present invention relates to a wireless terminal that includes a wireless communication unit that transmits/receives wireless signals with a smell diffusion apparatus, a user interface that receives control variable values for controlling the driving of the smell diffusion apparatus, and a controller that estimates the distance between the smell diffusion apparatus and the wireless terminal using the wireless signals transmitted/received by the wireless communication unit and adjusts the control variable values input based on the estimated distance to allow smell diffusion control signals to be output, and a control method for diffusing smell thereof. With the present invention, the control variable values of the smell diffusion apparatus, such as the smell diffusion time point, smell diffusion intensity, and smell diffusion duration time, etc., are adjusted according to the distance between the smell diffusion apparatus and the wireless terminal, making it possible to provide more improved smell diffusion services depending on the user.

### TECHNICAL FIELD

The present invention relates to a wireless terminal and a control method for diffusing smell thereof, and more particularly, to a wireless terminal that adjusts control variable values according to distance between the wireless terminal and a control smell diffusion apparatus, and a method for diffusing smell thereof.

### BACKGROUND ART

Recently, various multimedia services using digital contents have been provided, together with the popularization of digitalized video and audio equipment, and more realistic services have been gradually provided through the expansion of media such as the sense of smell and the sense of touch, etc., in addition to the visual and auditory senses in the related art. Therefore, wire/wireless-based digital smell diffusion apparatuses that can be controlled using a computer have been developed and methods that are synchronized with the visual and auditory media in the related art have been studied.

For example, there is a method to control a smell diffusion apparatus according to the setting input by a user by providing the smell diffusion apparatus in a mobile terminal.

### DISCLOSURE OF INVENTION

### Technical Problem

However, in the case of the smell diffusion apparatus, if the user is positioned distant from the smell diffusion apparatus, smell may not be reached to the user at a timely moment depending on the diffusion speed of the smell, and if the smell is weak, the user may not feel thereof.

### Technical Solution

It is an object of the present invention to provide a wireless terminal that calculates smell transfer delay time by estimating the distance between the wireless terminal and a smell diffusion apparatus to enable to adjust control variable values for the smell diffusion apparatus based thereon, and a control method for diffusing smell thereof.

In order to achieve the above object, there is provided a wireless terminal according to the present invention, the wireless terminal that controls the driving of a smell diffusion apparatus, including: a wireless communication unit that transmits and receives wireless signals to and from the smell diffusion apparatus; a user interface that receives control variable values for controlling the driving of the smell diffusion apparatus; and a controller that estimates the distance between the smell diffusion apparatus and the wireless terminal using the wireless signals transmitted and received by the wireless communication unit and adjusts the control variable values input based on the estimated distance to allow smell diffusion control signals to be output.

Meanwhile, in order to achieve the above object, there is a provided a control method for diffusing smell of a wireless terminal, the control method for diffusing smell of the wireless terminal that controls the driving of a smell diffusion apparatus, including: estimating the distance between the smell diffusion apparatus and the wireless terminal from wireless signals received from the smell diffusion apparatus; if control variable values for controlling the driving of the smell diffusion apparatus are input, adjusting the control variable values based on the estimated distance; and outputting smell diffusion control signals for controlling the driving of the smell diffusion apparatus based on the control variable values.

### Advantageous Effects

With the present invention, the control variable values of the smell diffusing apparatus, such as the smell diffusion time point, smell diffusion intensity, and smell diffusion duration, etc. are adjusted according to the distance between the smell diffusion apparatus and the wireless terminal, making it possible to provide more improved smell diffusion services depending on the positions of the user.

### BRIEF DESCRIPTION OF DRAWINGS

FIGS. 1 and 2 are diagrams referred to when explaining a constitution of a wireless terminal according to the present invention;

FIG. 3 is diagrams referred to when explaining an operation of the wireless terminal according to the present invention; and

FIGS. 4 and 5 are flowcharts showing an operational flow of the wireless terminal according to the present invention.

### BEST MODE FOR CARRYING OUT THE INVENTION

Hereinafter, exemplary embodiments of the present invention will be described with reference to the accompanying drawings.

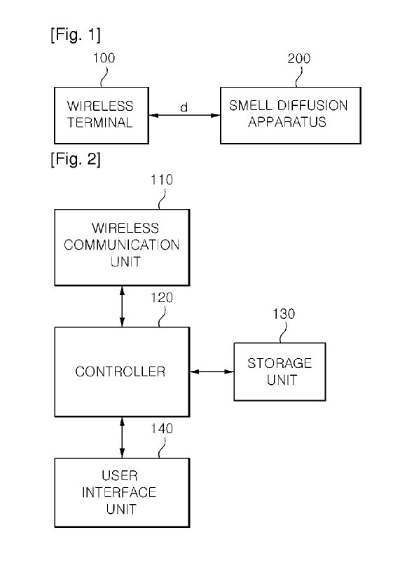

FIG. 1 is a diagram showing a connection configuration between a wireless terminal according to the present invention and a smell diffusion apparatus, and FIG. 2 is a block diagram showing a constitution of the wireless terminal according to the present invention.

Describing the wireless terminal according to the present invention with reference to FIGS. 1 and 2, the wireless terminal 100 and the smell diffusion apparatus 200 are apparatuses that are separately provided, wherein the wireless terminal 100 controls the driving of the smell diffusion apparatus 200 depending on the distance between the wireless terminal 100 and the smell diffusion apparatus 200 after the wireless terminal 100 and the smell diffusion apparatus are synchronized.

Here, the wireless terminal 100, which is a fixed or portable terminal, is characterized in that a Near Field Communication (NFC) can be performed. The smell diffusion apparatus 200 is characterized in that a wireless communication with the wireless terminal 100 can be performed. At this time, the wireless terminal 100 can be communicated with the smell diffusion apparatus 200 by the NFC method.

The wireless terminal 100 includes a wireless communication unit 110 that transmits and receives synchronization signals to and from the smell diffusion apparatus 200, a user interface 140 that receives a control command from a user and outputs a predetermined data, a controller 120 that issues smell diffusion control signals for the smell diffusion apparatus 200 according to the control command input through the user interface 140, and a storage unit 130 that stores control data between the smell diffusion apparatus 200 and the wireless terminal 100.

RFID, WiFi, Bluetooth, Zigbee, Ultra Wide Band (UWB), ultrasonic or infrared communication, etc. may be provided by way of one example of a communication interface that is supported by the wireless communication unit 110, wherein the wireless communication unit 110 supports a single or a plurality of Near Field Communication Interfaces.

The user interface 140, which is a device that receives a predetermined control command from a user or outputs a predetermined data to be confirmed by the user, may be formed integrally with the wireless terminal 100. On the other hand, the user interface 140 may be provided outside separately to be connected by wire or wirelessly to the wireless terminal 100. Also, the user interface 140 may be provided such that an input device and an output device are provided separately but may also be provided such that the input device and the output device are provided integrally (for example, a touch screen).

The storage unit 130 stores distance information between the wireless terminal 100 and the smell diffusion apparatus 200, and stores smell diffusion delay time information according to the distance information between the wireless terminal 100 and the smell diffusion apparatus 200. Also, the storage unit 130 stores predetermined control variable values for controlling the driving of the smell diffusion apparatus 200 to provide predetermined information stored according to the requests of the controller 120.

The controller 120 outputs synchronization signals for signal synchronization with the smell diffusion apparatus 200 through the wireless communication unit 110. At this time, when receiving response signals in correspondence with the synchronization signals transmitted through the wireless communication unit 110, the controller 120 synchronizes the wireless terminal 100 and the smell diffusion apparatus 200.

Meanwhile, the controller 120 estimates the distance between the wireless terminal 100 and the smell diffusion apparatus 200 based on the response signals received from the smell diffusion apparatus 200. At this time, the controller 120 analyzes the signals using at least one of the intensity of signals received from the smell diffusion apparatus 200, transmitting and receiving power, and angle received with the response signals, and estimates the distance between the wireless terminal 100 and the smell diffusion apparatus 200 based thereon. At this time, the estimated distance information is stored in the storage unit 130.

Meanwhile, the controller 120 compares the estimated distance between the wireless terminal 100 and the smell diffusion apparatus 200 with pre-set reference values. Here, the reference values mean a distance to the extent that errors between smell diffusion time of the smell diffusion apparatus 200 and time rendered when the diffused smell is reached to the user are hardly noticed by the user, wherein they may be changed according to the setting.

When the estimated distance is the reference values or less, the controller 120 determines that the smell diffusion delay time is ‘0’. Meanwhile, when the estimated distance exceeds the reference values, the controller 120 determines that the smell diffusion delay time exists to calculate the smell diffusion delay time according to the estimated distance. Here, the controller 120 calculates the smell diffusion delay time in consideration of information such as smell molecular weight diffused by the smell diffusion apparatus 200, diffusion velocity, temperature, humidity, and pressure, etc. At this time, the controller 120 allows the calculated smell diffusion delay time information to be stored in the storage unit 130.

Meanwhile, if the smell diffusion requests is not input by the user until a predetermined time elapses after the small diffusion delay time is calculated, the controller 120 reestimates the distance between the wireless terminal 100 and the small diffusion apparatus 200. At this time, although synchronization can be performed again, it may also be omitted according to the setting.

In this case, when the distance between the wireless terminal 100 and the smell diffusion apparatus 200 is sensed to be changed as the distance between the wireless terminal 100 and the smell diffusion apparatus 200 is estimated again, the controller 120 recalculates the smell diffusion delay time based on the reestimated distance information in the same manner. Of course, only when the reestimated distance exceeds the reference values, the controller 120 recalculates the smell diffusion delay time.

Thereafter, if control variables for driving the smell diffusion apparatus 200 are input through the user interface 140, together with the smell diffusion requests from the user, the controller 120 confirms whether the smell diffusion delay time information stored in the storage unit 130 exists.

If the stored smell diffusion delay time information does not exist, the controller 120 issues smell diffusion control signals based on the control variable values input through the user interface 140 and allows them to be output to the smell diffusion apparatus 200 through the wireless communication unit 110. Therefore, the smell diffusion apparatus 200 is driven according to the control variable values. To the contrary, if the stored smell diffusion delay time information exists, the controller 120 adjusts the control variable values input through the user interface 140 based on the smell diffusion delay time information and issues the smell diffusion control signals according to the adjusted control variable values. At this time, the wireless communication unit 110 outputs the smell diffusion control signals issued through the controller 120 to the smell diffusion apparatus 200, thereby allowing the smell diffusion apparatus 200 to be driven by the control variable values.

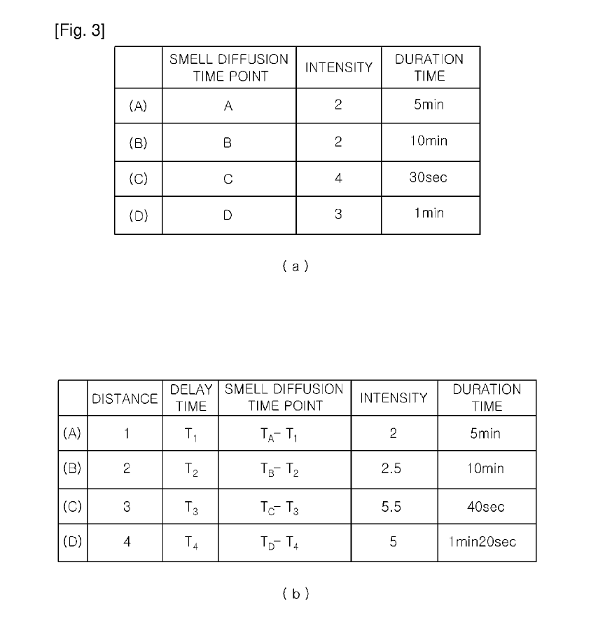

FIG. 3 show an embodiment for the smell diffusion control variables according to the present invention, wherein FIG. 3 (a) shows the smell diffusion control variables input through the user interface 140 and FIG. 3 (b) shows the smell diffusion control variables adjusted according to the smell diffusion delay time.

Here, the smell diffusion control variables are represented as smell diffusion time point, smell diffusion intensity, and smell diffusion duration, but are not limited thereto and specific items may be added or deleted according to the setting.

FIG. 3 (a) shows the variable values for (A), (B), (C) and (D) having different smell diffusion control variable values, respectively. First, (A) has the smell diffusion time point of TA, the smell diffusion intensity of 2, and the smell diffusion duration time of 5 min. Meanwhile, (B) has the smell diffusion time point of TB, the smell diffusion intensity of 2, and the smell diffusion duration time of 10 min. Also, (C) has the smell diffusion time point of TC, the smell diffusion intensity of 4, and the smell diffusion duration time of 30 sec. Also, (D) has the smell diffusion time point of TD, the smell diffusion intensity of 3, and the smell diffusion duration time of 1 min.

FIG. 3 (b) shows the smell diffusion control variable values adjusted by the smell diffusion delay time according to the distance between the wireless terminal and the smell diffusion apparatus for (A), (B), (C), and (D) of FIG. 3 (a).

In other words, (A) has the distance between the wireless terminal 100 and the smell diffusion apparatus 200 of ‘1’ and the smell diffusion delay time accordingly thereof of ‘T1’. At this time, assuming that the reference values for the distance are ‘1’, the distance d between the wireless terminal 100 and the smell diffusion apparatus 200 is the same as the reference values so that the smell diffusion delay time T1 accordingly thereof becomes ‘0’. Therefore, the smell diffusion time point, the smell diffusion intensity, and the smell diffusion duration time are the same as the control variable values input from the user.

Meanwhile, (B) has the distance d between the wireless terminal 100 and the smell diffusion apparatus 200 of ‘2’ and the smell diffusion delay time accordingly thereof of ‘T2’, At this time, since the distance d between the wireless terminal 100 and the smell diffusion apparatus 200 exceeds the reference values, the smell diffusion delay time T2 is generated accordingly. Therefore, the smell diffusion time point becomes ‘TB-T2’ that is precedent by the smell diffusion delay time of ‘T2’ from the smell diffusion time point of ‘TB’ initially input. Also, as the distance becomes more distant compared to the reference values, the smell diffusion intensity is adjusted from the initially input values of ‘2’ to ‘2.5’.

Meanwhile, (C) has the distance d between the wireless terminal 100 and the smell diffusion apparatus 200 of ‘3’, and the smell diffusion delay time accordingly thereof of ‘T3’. At this time, since the distance d between the wireless terminal 100 and the smell diffusion apparatus 200 exceeds the reference values, the smell diffusion delay time T3 is generated accordingly. Therefore, the smell diffusion time point becomes ‘TC-T3’ that is preceded by the smell diffusion delay time of ‘T3’ from the smell diffusion time point of ‘TC’ initially input. Also, as the distance becomes more distant compared to the reference values, the smell diffusion intensity is adjusted from the initially input values of ‘4’ to ‘5.5’ and the duration time is also adjusted from ‘30 sec’ to ‘40 sec’.

Meanwhile, (D) has the distance d between the wireless terminal 100 and the smell diffusion apparatus 200 of ‘4’ and the smell diffusion delay time accordingly thereof of ‘T4’. At this time, since the distance d between the wireless terminal 100 and the smell diffusion apparatus 200 exceeds the reference values, the smell diffusion delay time T4 is generated accordingly. Therefore, the smell diffusion time point becomes ‘TD-T4’ that is preceded by the smell diffusion delay time of ‘4’ from the smell diffusion time point of ‘TD’ initially input. Also, as the distance becomes more distant compared to the reference values, the smell diffusion intensity is adjusted from the initially input values of ‘3’ to ‘5’ and the duration time is also adjusted from ‘1 min’ to ‘1 min 20 sec’.

Of course, since the embodiment of FIG. 3 (b) is for more efficiently explaining the present invention, actual estimation data are not described thereon and the present invention is not limited thereto, either.

Hereinafter, a control method for diffusing smell of a wireless terminal according to the present invention will be described in more detail with reference to the constitution as described above.

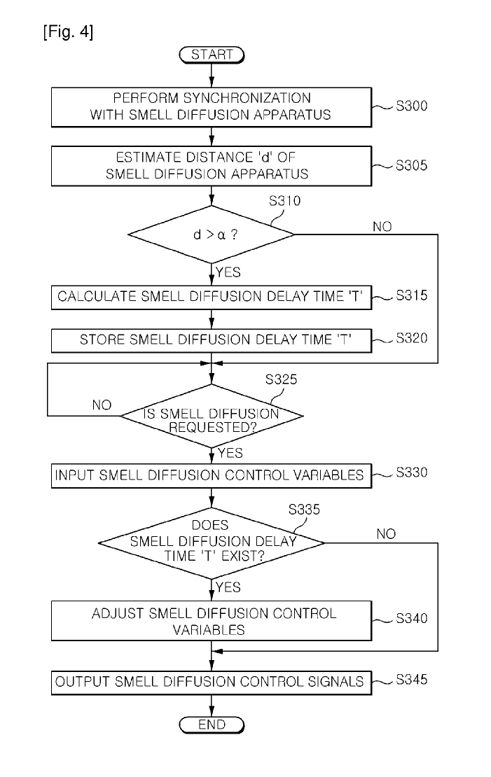

FIG. 4 is a flowchart showing an operational flow of a method for diffusing smell of the wireless terminal according to an embodiment of the present invention, the embodiment where the wireless terminal is a fixed terminal.

Referring to FIG. 4, a wireless communication unit 110 transmits wireless signals to a smell diffusion apparatus 200 and receives signals transmitted from the smell diffusion apparatus 200 at this time. At this time, the transmitted and received signals include synchronization signals. A controller 120 is synchronized with the smell diffusion apparatus 200 based on the wireless signals received by the wireless communication unit 110 (S300), and at this time, the controller 120 estimates the distance d with the smell diffusion apparatus 200 using signal receiving intensity, transmitting and receiving power level, and signal receiving angle, etc. (S305).

Also, the controller 120 calculates smell diffusion delay time T from the estimated distance d (S315) to store the smell diffusion delay time T in a storage unit 130 (S320). At this time, the stored smell diffusion delay time T information is called when smell diffusion is requested. When the values of the estimated distance d are compared with the pre-set reference values α (S310), if the values of the estimated distance d are the reference values α or less, steps ‘S315’ and ‘S320’ are omitted.

Meanwhile, a user interface 140 receives control variable values for driving the smell diffusion apparatus 200 (S330), when the smell diffusion is requested (S325). Here, the control variable values include smell diffusion time point, intensity, and duration time, etc. At this time, the controller 120 calls the smell diffusion time information that is stored in the storage unit 130. If the smell diffusion delay time information stored in the storage unit 130 does not exist (S335), the controller 120 outputs smell diffusion control signals based on the control variable values input through the user interface 140 (S345).

Meanwhile, if the smell diffusion delay time information stored in the storage unit 130 exists (S335), the controller 120 calls the smell diffusion delay time information stored in the storage unit 130 and adjusts the smell diffusion control variable values input through the user interface 140 based on the called smell diffusion delay time (S340). In other words, when the smell diffusion delay time is long due to the long distance between the wireless terminal 100 and the smell diffusion apparatus 200, the controller 120 advances the smell diffusion time point by the smell diffusion delay time accordingly and the smell diffusion intensity to be also increased.

The controller 120 outputs the smell diffusion control signals based on the control variable values adjusted according to the smell diffusion delay time. At this time, the wireless communication unit 110 transmits the smell diffusion control signals to the smell diffusion apparatus 200, such that the smell diffusion apparatus 200 is driven according to the smell diffusion control signals (S345).

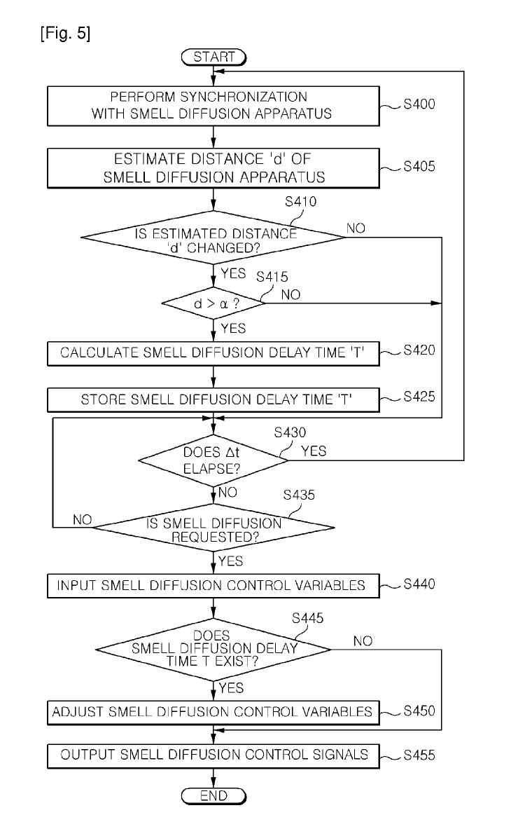

FIG. 5 is a flowchart showing an operational flow of the method for diffusing smell of the wireless terminal according to another embodiment of the present invention, the operational flow of the wireless terminal which is a portable terminal.

As shown in FIG. 5, a wireless communication unit 110 transmits wireless signals to a smell diffusion apparatus 200 and receives signals transmitted from the smell diffusion apparatus 200 at this time. At this time, the controller 120 is synchronized with the smell diffusion apparatus 200 based on the signals received by the wireless communication unit 110 (S400) and estimates the distance between the wireless terminal 100 and the smell diffusion apparatus 200 therethrough (S405). Here, step ‘S410’ which confirms whether the estimated distance is changed is omitted at the time of an initial connection to the smell diffusion apparatus 200.

At this time, when the values of the estimated distance d is compared with the pre-set reference values α (S415), if the values of the estimated distance d exceed the reference values α, the controller 120 calculates smell diffusion delay time T from the estimated distance d (S420) and allows the smell diffusion delay time T to be stored in a storage unit 130 (S425). To the contrary, if the values of the estimated distance d are the reference values α or less, steps ‘S420’ and ‘S425’ are omitted.

If the smell diffusion is not requested until a predetermined time elapses after the distance with the smell diffusion apparatus is estimated (S430 and S435), the controller 120 performs again steps ‘S400’ to ‘425’. At this time, if the estimated distance for the smell diffusion apparatus 200 is different from the pre-estimated distance (S410), the controller 120 recalculates the smell diffusion delay time according to the changed distance (S420) and allows the smell diffusion delay time to be stored in the storage unit 130 (S425). If the estimated distance for the smell diffusion apparatus 200 is the same as the pre-estimated distance, steps ‘S415’ to ‘S425’ are omitted.

Meanwhile, when the smell diffusion is requested by the user (S435), the user interface 140 receives control variable values for driving the smell diffusion apparatus (S440). Here, the control variable values include smell diffusion time point, smell diffusion intensity, and smell diffusion duration time, etc. At this time, the controller 120 calls the smell diffusion delay time information stored in the storage unit 130.

The controller 120 adjusts the control variable values input by the user interface 140 based on the called smell diffusion delay time information (S450). In other words, when the smell diffusion delay time is long due to the long distance between the wireless terminal 100 and the smell diffusion apparatus 200, the controller 120 advances the smell diffusion time point accordingly and the smell diffusion intensity to also be raised. At this time, the controller 120 allows the smell diffusion control signals to be output to the smell diffusion apparatus 200 based on the adjusted control variable values (S455). If the called smell diffusion delay time information does not exist (S445), the controller 120 outputs the smell diffusion control signals according to the control variable values input through the user interface 140 (S455).

As described above, although the wireless terminal and the control method for diffusing smell thereof according to the present invention are described with reference to the exemplified drawings, the present invention is not limited to the embodiments and the drawings set forth in the specification, but may be applied in the range by the technical idea is protected.

1. A wireless terminal that controls the driving of a smell diffusion apparatus, comprising:
a wireless communication unit that transmits and receives wireless signals to and from the smell diffusion apparatus;
a user interface that receives control variable values for controlling the driving of the smell diffusion apparatus; and
a controller that estimates the distance between the smell diffusion apparatus and the wireless terminal using the wireless signals transmitted and received by the wireless communication unit and adjusts the control variable values input based on the estimated distance to allow smell diffusion control signals to be output.

2. The wireless terminal according to claim 1, wherein the wireless signals include synchronization signals for being synchronized with the smell diffusion apparatus.

3. The wireless terminal according to claim 1, wherein the control variable values include at least one of smell diffusion time point, smell diffusion intensity, and smell duration time.

4. The wireless terminal according to claim 1, wherein the controller estimates the distance based on at least one of arriving time, signal receiving intensity, and signal receiving angle of the wireless signals.

5. The wireless terminal according to claim 1, wherein when the values of the estimated distance are compared with pre-set reference values and the values exceed the pre-set reference values, the controller adjusts the control variable values based on the values of the distance.

6. The wireless terminal according to claim 1, wherein the controller calculates smell diffusion delay time for the smell diffusion apparatus from the estimated distance and adjusts the smell diffusion time point among the control variable values based on the smell diffusion delay time.

7. The wireless terminal according to claim 1, wherein if smell diffusion is not requested until a predetermined time elapses after the distance with the smell diffusion apparatus is estimated, the controller reestimates the distance between the smell diffusion apparatus and the wireless terminal.

8. A control method for diffusing smell of a wireless terminal that controls the driving of a smell diffusion apparatus, comprising:
estimating the distance between the smell diffusion apparatus and the wireless terminal from wireless signals received from the smell diffusion apparatus;
if control variable values for controlling the driving of the smell diffusion apparatus are input, adjusting the control variable values based on the estimated distance; and
outputting smell diffusion control signals for controlling the driving of the smell diffusion apparatus based on the control variable values.

9. The control method for diffusing smell of the wireless terminal according to claim 8, wherein the control variable values include at least one of smell diffusion time point, smell diffusion intensity, and smell duration time.

10. The control method for diffusing smell of the wireless terminal according to claim 8, wherein the estimating the distance comprises estimating the distance based on at least one of arriving time, signal receiving intensity, and signal receiving angle of the wireless signals.

11. The control method for diffusing smell of the wireless terminal according to claim 8, further comprising:
comparing the estimated distance with pre-set reference values, wherein when the values of the estimated distance exceed the reference values, the control variable values are adjusted based on the values of the estimated distance.

12. The control method for diffusing smell of the wireless terminal according to claim 8, wherein the estimating the distance is performed again when smell diffusion for the smell diffusion apparatus is not requested until a predetermined time elapses.

13. The control method for diffusing smell of the wireless terminal according to claim 8, further comprising, after the estimating the distance:
calculating smell diffusion delay time for the smell diffusion apparatus from the estimated distance,
wherein the smell diffusion time point among the control variable values is adjusted based on the smell diffusion delay time.

14. The control method for diffusing smell of the wireless terminal according to claim 8, further comprising:
confirming whether the distance between the smell diffusion apparatus and the wireless terminal is changed,
wherein when the distance is changed, the control variable values are readjusted based on the changed distance.
